(19) United States
(12) Patent Application Publication
(10) Pub. No.: US 2026/0217359 A1
(43) Pub. Date: Jul. 30, 2026

(54) AIRCRAFT COMPRISING AT LEAST ONE INFLATABLE AERODYNAMIC STRUCTURE

(71) Applicant: Airbus Operations SAS, TOULOUSE (FR)

(72) Inventor: Vincent MAZARS, TOULOUSE (FR)

(21) Appl. No.: 19/453,429

(22) Filed: Jan. 20, 2026

(30) Foreign Application Priority Data
Jan. 28, 2025 (FR) FR2500857

(51) Int. Cl. B64C 7/00

(52) U.S. Cl. CPC B64C 7/00

(57) ABSTRACT

An aircraft comprising with at least one support, at least one inflatable aerodynamic structure which has at least one aerodynamic surface, and at least one connection system connecting the aerodynamic structure and the support. The aerodynamic structure has at least one flexible wall having an outer face, and at least one inflatable cavity delimited at least partially by the flexible wall and configured to adopt an inflated state in which the cavity has a maximum volume and a deflated state in which the cavity has a volume smaller than the maximum volume, the outer face forming at least part of the aerodynamic surface when the cavity is in the inflated state.

### CROSS-REFERENCES TO RELATED APPLICATIONS

This application claims the benefit of French Patent Application Number FR2500857 filed on Jan. 28, 2025, the entire disclosure of which is incorporated herein by way of reference.

### FIELD OF THE INVENTION

The present application relates to an aircraft comprising at least one inflatable aerodynamic structure.

### BACKGROUND OF THE INVENTION

An aircraft comprises aerodynamic structures such as a fairing, for example, configured to optimize the flow of air around the aircraft and reduce its drag. By way of example, an aerodynamic structure which does not provide a mechanical function and the transmission of loads, also referred to as non-structural, may be a Karman-type structure situated at the junction connecting the wing and the fuselage of the aircraft.

According to one embodiment, an aerodynamic structure of this kind comprises a rigid wall forming part of the skin of the aircraft and a secondary structure on which the wall rests, giving it a certain stiffness. The wall is produced from a rigid metal or composite plate shaped according to the desired three-dimensional geometric shape of the wall. In addition, the secondary structure is made of metal or composite material and manufactured so as to match the three-dimensional geometric shape of the wall.

These aerodynamic structures generally have a relatively high density. Furthermore, given their complex geometric shapes, aerodynamic structures of this kind are complex to manufacture and to install. Finally, they are generally impact-sensitive and difficult to repair.

The present invention aims to remedy all or some of the disadvantages of the prior art.

### SUMMARY OF THE INVENTION

To this end, the object of the invention is an aircraft comprising at least one support, at least one aerodynamic structure which has at least one aerodynamic surface, and at least one connection system connecting the aerodynamic structure and the support.

According to the invention, the aerodynamic structure comprises at least one flexible wall having an outer face, and at least one inflatable cavity delimited at least partially by the flexible wall and configured to adopt an inflated state in which the cavity has a maximum volume and a deflated state in which the cavity has a volume smaller than the maximum volume, the outer face forming at least a part of the aerodynamic surface when the cavity is in the inflated state.

This inflatable aerodynamic structure has a density that is markedly lower than that of an aerodynamic structure of the prior art and can be installed more simply than the latter.

According to another feature, the aerodynamic structure comprises a plurality of flexible walls connected to one another in a sealed manner.

According to another feature, the aerodynamic structure comprises internal meshes each connecting two flexible walls.

According to another feature, the aerodynamic structure comprises a plurality of cavities, at least one of which is inflatable.

According to another feature, the aerodynamic structure comprises:
a first inflatable cavity delimited by first and second flexible walls having first lateral edges connected to one another and to the support in a sealed manner and second lateral edges connected to one another and to the support in a sealed manner, the first flexible wall having an outer face which, when the first cavity is in the inflated state, has a geometry identical to that of the aerodynamic surface,
a second cavity separated from the first cavity by the second flexible wall and delimited by said second flexible wall and the support,
internal meshes, situated in the first cavity, connecting the first and second walls.

According to another feature, the aerodynamic structure comprises at least first and second inflatable cavities, the first and second inflatable cavities each having at least first, second and third flexible walls; the first flexible walls of the first and second cavities forming at least a part of the aerodynamic surface of the aerodynamic structure, the second flexible walls of the first and second cavities bearing against the support, the third flexible walls of the first and second cavities bearing against one another.

According to another feature, the aerodynamic structure comprises at least one film covering at least part of the outer face of the flexible wall.

According to another feature, the connection system comprises at least one bonding film interposed between at least one of the flexible walls and the support.

According to another feature, the aerodynamic structure comprises a plurality of connection systems.

According to another feature, at least one connection system comprises a slide which has an elongate housing connected to the support and a bead or insert connected to at least one of the flexible walls and configured to be positioned in the elongate housing, said elongate housing having a constricted opening with a cross section smaller than that of the bead or of the insert.

According to another feature, at least one connection system comprises at least one profile element separate from the support and connected to the support by fastening elements, at least one flexible wall cooperating with said profile element.

According to another feature, the aerodynamic structure comprises at least one pressure-regulation system configured to regulate the pressure of the fluid present in said at least one inflatable cavity.

According to another feature, the pressure-regulation system comprises a pressurized-fluid supply and at least one control, which is actuable or set, configured to allow or prevent a flow of a fluid contained in the pressurized-fluid supply towards the cavity.

According to another feature, the pressure-regulation system is configured to regulate the pressure of the fluid present in the inflatable cavity in such a manner that the aerodynamic surface retains a constant geometry.

According to another feature, the pressure-regulation system is configured to regulate the pressure of the fluid present in the inflatable cavity in such a manner that the aerodynamic surface has a geometry that varies.

According to another feature, the aerodynamic structure is of a Karman type.

### BRIEF DESCRIPTION OF THE DRAWINGS

Further features and advantages will become apparent from the description of the invention which follows, this description being provided solely by way of example with reference to the appended drawings, in which:

FIG. 1 is a side view of an aircraft;

FIG. 2 is a schematic section of a part of an aircraft comprising an inflatable aerodynamic structure illustrating one embodiment of the invention;

FIG. 3 is a schematic section of a part of an aircraft comprising an inflatable aerodynamic structure illustrating another embodiment of the invention;

FIG. 4 is a schematic section of a part of an aircraft comprising an inflatable aerodynamic structure illustrating another embodiment of the invention;

FIG. 5 is a schematic section of a part of an aircraft comprising an inflatable aerodynamic structure illustrating another embodiment of the invention;

FIG. 6 is a schematic section of a part of an aircraft comprising an inflatable aerodynamic structure illustrating another embodiment of the invention;

FIG. 7 is a schematic section of a part of an aircraft comprising an inflatable aerodynamic structure illustrating another embodiment of the invention;

FIG. 8 is a schematic section of a part of an aircraft comprising an inflatable aerodynamic structure illustrating another embodiment of the invention;

FIG. 9 is a schematic section of a connection system connecting an inflatable aerodynamic structure and a support of an aircraft illustrating one embodiment of the invention;

FIG. 10 is a schematic section of a connection system connecting an inflatable aerodynamic structure and a support of an aircraft illustrating another embodiment of the invention;

FIG. 11 is a schematic section of a connection system connecting an inflatable aerodynamic structure and a support of an aircraft illustrating another embodiment of the invention;

FIG. 12 is a schematic section of a connection system connecting an inflatable aerodynamic structure and a support of an aircraft illustrating another embodiment of the invention;

FIG. 13 is a schematic section of a part of an aircraft comprising an inflatable aerodynamic structure and an external fluid supply system illustrating one embodiment of the invention;

FIG. 14 is a schematic section of a part of an aircraft comprising an inflatable aerodynamic structure and an internal fluid supply system illustrating one embodiment of the invention; and,

FIG. 15 is a schematic section of an inflatable aerodynamic structure in different states illustrating one embodiment of the invention.

### DETAILED DESCRIPTION OF THE PREFERRED EMBODIMENTS

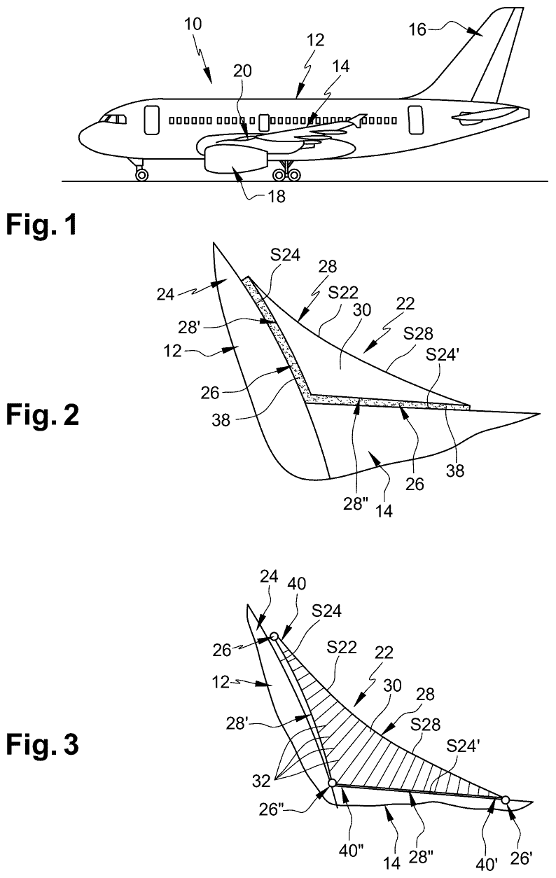

According to an embodiment shown in FIG. 1, an aircraft 10 comprises a fuselage 12, wings 14 positioned on either side of the fuselage 12, a tail unit 16 situated at the rear end of the fuselage 12, and propulsion assemblies 18 situated under the wings 14 and connected thereto by pylons 20.

As illustrated in FIG. 2, the aircraft 10 comprises an aerodynamic structure 22, such as a Karman-type structure, for example, in the region of a junction zone between the fuselage 12 and each wing 14. This aerodynamic structure is referred to as non-structural, to the extent that it does not provide any mechanical function or load transmission. Of course, the invention is not limited to this position for the aerodynamic structure 22.

Whatever the embodiment, the aircraft 10 comprises at least one support 24 having:
at least one element from among the fuselage 12, one of the wings 14, the tail unit 16, one of the propulsion assemblies 18, one of the pylons 20 or any other part of the aircraft 10,
at least one aerodynamic structure 22,
at least one connection system 26 connecting the aerodynamic structure 22 and the support 24.

The support 24 comprises at least one contact surface S24 on which the aerodynamic structure 22 is positioned. In one arrangement, the support 24 comprises first and second contact surfaces S24, S24′ against which the aerodynamic structure 22 is positioned. In this arrangement, the first contact surface S24 corresponds to a part of the outer surface of the fuselage 12 and the second contact surface S24′ corresponds to a part of the outer surface of one of the wings 14. These first and second contact surfaces S24, S24′ form a V in a transverse plane.

As an alternative, the support 24 comprises at least one contact point to which the aerodynamic structure 22 is connected.

The aerodynamic structure 22 has at least one aerodynamic surface S22 in contact with an airflow flowing around the outside of the aircraft 10 in flight. This aerodynamic surface S22 has a given geometry.

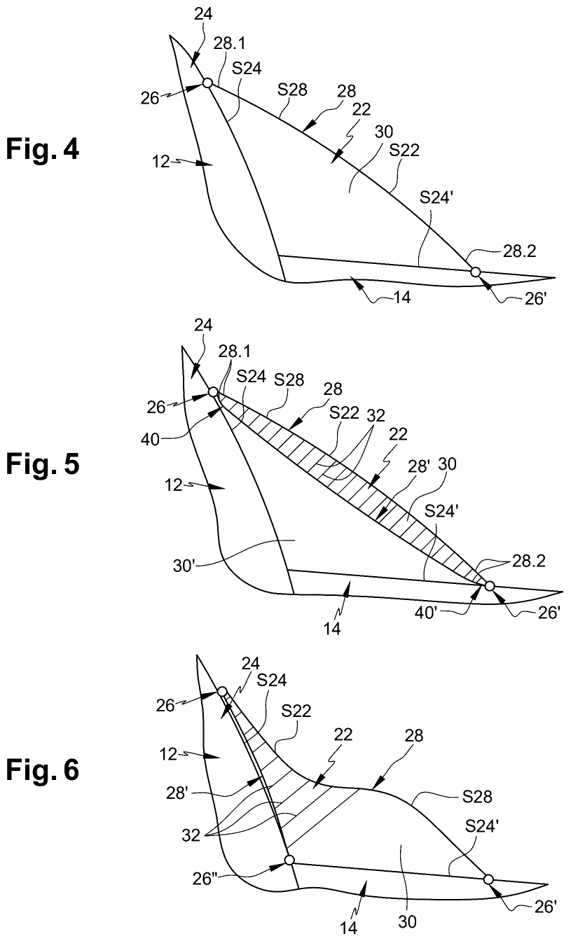

This aerodynamic surface S22 may be flat, concave as illustrated in Figures and 3, convex as illustrated in FIGS. 4 and 5, may have a convex part and another concave part as illustrated in FIG. 6, or may have any other geometry.

The aerodynamic structure 22 comprises at least one flexible wall 28 at least partially delimiting at least one inflatable cavity 30 configured to adopt an inflated state in which it has a maximum volume and a deflated state in which it has a volume smaller than the maximum volume. The flexible wall 28 has an outer face S28 which forms at least a part of the aerodynamic surface S22 when the cavity 30 is in the inflated state.

According to an embodiment shown in FIG. 2, the aerodynamic structure 22 comprises a plurality of flexible walls 28, 28′, 28″ connected to one another in a sealed manner so as to form an inflatable cavity 30. In this embodiment which is shown in FIG. 2, the cavity 30 has no internal reinforcement or mesh. The aerodynamic structure 22 comprises a first wall 28 having an outer face S28 which, when the cavity 30 is in the inflated state, has the same geometry as the aerodynamic surface S22 and forms said aerodynamic surface S22. In addition, the aerodynamic structure 22 comprises second and third flexible walls 28′, 28″ bearing against the support 24.

According to another embodiment which is shown in FIGS. 3 and 6, the aerodynamic structure 22 comprises internal meshes 32 each connecting two flexible walls 28, 28′, 28″. The aerodynamic structure 22 comprises a first wall 28 having an outer face S28 which, when the cavity 30 is in the inflated state, has the same geometry as the aerodynamic surface S22 and forms said aerodynamic surface S22. In addition, the aerodynamic structure 22 comprises second and third flexible walls 28′, 28″ bearing against the support 24.

For the present application, an internal mesh 32 is understood to mean a flexible, inextensible connecting element connecting two flexible walls 28, 28′, 28″. Hence, the internal meshes 32 may be ribs, threads, straps or the like.

According to a configuration shown in FIG. 3, the internal meshes 32 occupy the entire interior space of the cavity 30. According to another configuration shown in FIG. 6, the internal meshes 32 occupy only part of the interior space of the cavity 30.

According to one embodiment, each flexible wall 28, 28′, 28″ comprises a stack of several sealed layers in contact with one another. Each flexible wall 28, 28′, 28″ may be made of a non-extensible or extensible material, transparent or not, and may be reinforced or not by fibers or fabrics that are resistant to loads and impacts.

According to another embodiment shown in FIG. 4, the aerodynamic structure 22 comprises a single flexible wall 28 which extends between first and second lateral edges 28.1, 28.2 that are connected in a sealed manner to the support 24. In this embodiment, the inflatable cavity 30 is delimited by the flexible wall 28 and the support 24.

According to another embodiment shown in FIG. 5, the aerodynamic structure 22 comprises a plurality of cavities 30, 30′, at least one of which is inflatable. In one arrangement, the aerodynamic structure 22 comprises:
a first inflatable cavity 30 delimited by first and second flexible walls 28, 28′ connected in a sealed manner to the support 24, the first flexible wall 28 having an outer face which, when the first cavity 30 is in the inflated state, has the same geometry as the aerodynamic surface S22,
a second cavity 30′ separated from the first cavity 30 by the second flexible wall 28′ and delimited by said second flexible wall and the support.

In this embodiment, the first and second flexible walls 28, 28′ comprise first lateral edges 28.1 connected to one another and to the support 24 in a sealed manner and second lateral edges 28.2 connected to one another and to the support 24 in a sealed manner. In one arrangement, the aerodynamic structure 22 comprises internal meshes 32, situated in the first cavity 30, connecting the first and second walls 28, 28′. In this arrangement, the first and second walls 28, 28′ form a rigid panel when the first cavity 30 is in the inflated state.

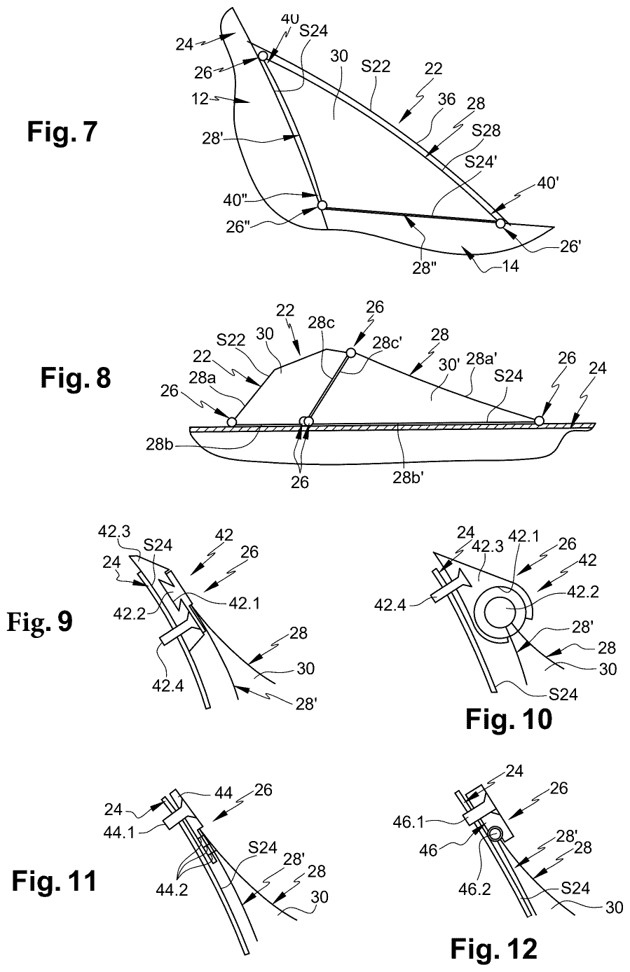

According to another embodiment shown in FIG. 8, the aerodynamic structure 22 comprises at least first and second inflatable cavities 30, 30′, the first inflatable cavity 30 having at least first, second and third flexible walls 28a, 28b, 28c, and the second inflatable cavity 30′ having at least first, second and third flexible walls 28a′, 28b′, 28c′; the first flexible walls 28a, 28a′ of the first and second cavities 30, 30′ forming at least a part of the aerodynamic surface S22 of the aerodynamic structure 22, the second flexible walls 28b, 28b′ of the first and second cavities 30, 30′ bearing against the support 24, the third flexible walls 28c, 28c′ of the first and second cavities 30, 30′ bearing against one another.

According to an embodiment shown in FIG. 7, the aerodynamic structure 22 comprises at least one rigid plate or sheet 36 covering at least part of the outer face S28 of the flexible wall 28. This plate or sheet 36 may be metallic or made of a composite material and may cover the entire flexible wall 28. It forms an aerodynamic surface which is supported on the aerodynamic structure 22 and enables the latter to retain a given shape.

According to an embodiment shown in FIG. 2, the connection system 26 comprises at least one bonding film 38, such as an adhesive film or a hook-and-loop fastener strip of the Velcro® type, for example, interposed between at least one of the flexible walls 28′, 28″ and the support 24. This type of connection system 26 is a surface type.

According to another embodiment shown in FIGS. 3 and 4 to 8, the aerodynamic structure 22 comprises a plurality of connection systems 26, 26′, 26″ of linear type, each of which extends along a line.

In the embodiment shown in FIG. 4, when the aerodynamic structure 22 comprises a single flexible wall 28 which extends between first and second lateral edges 28.1, 28.2, said aerodynamic structure 22 comprises first and second connection systems 26, 26′ which each extend along the first and second lateral edges 28.1, 28.2.

In the embodiment shown in FIG. 5, when the aerodynamic structure 22 comprises first and second flexible walls 28, 28′ which have first lateral edges 28.1 connected to one another in a sealed manner at a first junction zone 40 and second lateral edges 28.2 connected to one another in a sealed manner at a second junction zone 40′, said aerodynamic structure 22 comprises first and second connection systems 26, 26′ which each extend along the first and second junction zones 40, 40′.

In the embodiments shown in FIGS. 3 and 7, when the aerodynamic structure 22 comprises a plurality of flexible walls 28, 28′, 28″ connected in pairs at junction zones 40, 40′, 40″, said aerodynamic structure 22 comprises, for each junction zone 40, 40′, 40″, a connection system 26, 26′, 26″ which extends along said junction zone 40, 40′, 40″.

Of course, the invention is not limited to these numbers or to these locations for the connection systems 26, 26′, 26″.

According to configurations shown in FIGS. 9 and 10, at least one connection system 26, 26′, 26″ comprises a slide 42 which has an elongate housing 42.1 connected to the support 24 and an elongate bead or insert 42.2 connected to at least one of the flexible walls 28, 28′, 28″ and configured to be positioned in the elongate housing 42.1, said elongate housing 42.1 having a constricted opening with a cross section smaller than that of the bead or insert 42.2. According to a first configuration shown in FIG. 9, the housing 42.1 and the bead 42.2 have dovetail-shaped cross sections. According to a second configuration shown in FIG. 10, the housing 42.1 and the bead 42.2 have circular cross sections.

In the first and second embodiments, the slide 42 comprises at least one profile element 42.3, separate from the support 24, which is connected to said support by fastening elements 42.4, such as screws or rivets for example, and has the housing 42.1.

According to another configuration shown in FIG. 11, at least one connection system 26, 26′, 26″ comprises a profile element 44 connected to the support 24 by first fastening elements 44.1, such as screws or rivets for example, the flexible wall or walls 28, 28′, 28″ being connected to said profile element 44 by second fastening elements 44.2, such as stitching for example.

According to another configuration shown in FIG. 12, at least one connection system 26, 26′, 26″ comprises a profile element 46 connected to the support 24 by fastening elements 46.1, such as screws or rivets for example, the flexible wall or walls 28, 28′, 28″ having a bead 46.2 clamped between the profile element 46 and the support 24. This profile element 46 may be in one piece or comprise a plurality of assembled elements.

In these various embodiments, at least one connection system 26, 26′, 26″ comprises at least one profile element 42.3, 44, 46 separate from the support 24 and connected to the support 24 by fastening elements 42.4, 44.1, 46.1, at least one flexible wall 28, 28′, 28″ cooperating with said profile element 42.3, 44, 46.

Of course, the invention is not limited to these configurations for the connection system 26, 26′, 26″. Hence, at least one connection system 26, 26′, 26″ may be, for example, a hinge with or without a removable pin, a zip fastener or a hook-and-loop fastener strip of the Velcro® type. This connection system may also be an adhesive strip.

In operation, at least one inflatable cavity 30, 30′ contains a fluid which, in the inflated state, has a pressure greater than or equal to 0.25 bar.

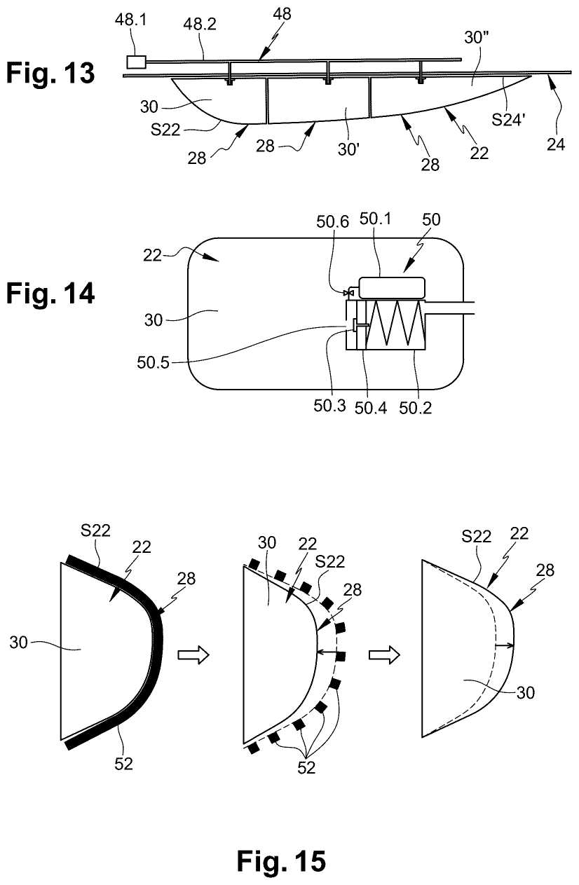

According to embodiments shown in FIGS. 13 and 14, the aerodynamic structure 22 comprises at least one pressure-regulation system 48 configured to regulate the pressure of the fluid present in at least one inflatable cavity 30, 30′.

According to an embodiment shown in FIG. 13, the pressure-regulation system 48 is situated outside the cavity 30. In this embodiment, the pressure-regulation system 48 comprises a pressurized-fluid supply 48.1, at least one conduit 48.2 connecting said pressurized-fluid supply 48.1 and the cavity 30, and at least one operable or preset control, such as a valve, pressure reducer or relief valve for example, configured to allow or prevent the flow of a fluid contained in the pressurized-fluid supply 48.1 towards the cavity 30. In one configuration, the pressure-regulation system 48 comprises a network of conduits 48.2 connecting the same pressurized-fluid supply and a plurality of cavities 30, 30′, 30″.

According to another embodiment shown in FIG. 14, at least one inflatable cavity 30 comprises its own pressure-regulation system 50 positioned inside the cavity 30. In this embodiment, the pressure-regulation system 50 comprises a compressed-gas reservoir 50.1, an expansion vessel 50.2, a valve 50.3, a piston 50.4 situated in the expansion vessel 50.2, an orifice 50.5 configured to be closed off by the valve 50.3 and to place the interior of the cavity 30 in communication with the interior of the expansion vessel 50.2, and an operable tap 50.6 allowing the compressed-gas reservoir 50.1 to be placed in communication with the interior of the expansion vessel 50.2. When the pressure inside the cavity 30 is greater than a first threshold value, the piston 50.4 moves to the right and allows gas to flow via the orifice 50.5 from the cavity 30 to the expansion vessel 50.2. When the pressure inside the cavity 30 is less than a second threshold value, the piston 50.4 moves to the left and causes the tap 50.6 to open.

Of course, the invention is not limited to these embodiments for the pressure-regulation system 48, 50.

According to a first mode of operation, the pressure-regulation system 48, 50 is configured to regulate the pressure in the inflatable cavity 30 in such a manner that the aerodynamic surface S22 retains a constant geometry.

According to a second mode of operation shown in FIG. 15, the pressure-regulation system 48, 50 is configured to regulate the pressure in the inflatable cavity 30 in such a manner that the aerodynamic surface S22 has a geometry that varies. Hence, the aerodynamic surface S22 assumes a first expanded state when the cavity 30 is in the inflated state and a second contracted state when the cavity 30 is in the deflated state.

In one application, it is possible to de-ice the aerodynamic surface S22 by deflating and reinflating it. As illustrated in the left part of FIG. 15, ice 52 may form on the aerodynamic surface S22 when the cavity 30 is in the inflated state. The ice 52 may be broken up by deflating the cavity 30, as illustrated in the middle part of FIG. 15. Because of this breaking up of the ice 52 and the aerodynamic flows over the aerodynamic surface S22, the ice 52 is removed from said aerodynamic surface S22. As illustrated in the right part of FIG. 15, the cavity 30 is then reinflated so that the aerodynamic surface S22 recovers its initial geometry.

According to another mode of operation, the geometry of the aerodynamic surface S22 is modified by regulating the pressure inside the cavity 30, in order to adapt it as a function of the phases of flight and to optimize aerodynamic performance. In this mode of operation, the flexible wall 28 forming the aerodynamic surface S22 may be extensible or elastic. Control of the geometry of the aerodynamic surface S22 may be of an active type, as in the case of the de-icing function described above. Alternatively, control of the geometry of the aerodynamic surface S22 may be of a passive type. In this variant, the geometry varies as a function of the difference in pressure between the internal pressure present in the cavity 30, which is constant, and the external pressure, which varies as a function of the altitude of the aircraft.

The inflatable aerodynamic structure 22 of the invention has a density that is markedly lower than that of an aerodynamic structure of the prior art and can be installed more simply than the latter.

Insofar as this inflatable aerodynamic structure 22 can be made of a material that is transparent to electromagnetic waves, it can be used to cover an antenna or a radar.

The aerodynamic structure 22 can be made of a transparent material such that it can cover a projector, a position light, any other light signal or at least one window.

Finally, this aerodynamic structure 22 can be used to simulate aerodynamic modifications by varying its geometry in order, for example, to simulate an accumulation of ice in a reversible and variable manner during flight tests.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority. Claimed is:

1. An aircraft comprising:
a support;
an aerodynamic structure which has an aerodynamic surface; and
a connection system connecting the aerodynamic structure and the support,
wherein the aerodynamic structure comprises a flexible wall having an outer face, and an inflatable cavity delimited at least partially by the flexible wall and configured to adopt an inflated state in which the inflatable cavity has a maximum volume and a deflated state in which the inflatable cavity has a volume smaller than the maximum volume, the outer face forming at least a part of the aerodynamic surface when the inflatable cavity is in the inflated state.

2. The aircraft according to claim 1, wherein the aerodynamic structure comprises a plurality of flexible walls connected to one another in a sealed manner.

3. The aircraft according to claim 2, wherein the aerodynamic structure comprises a plurality of internal meshes each connecting two flexible walls of the plurality of flexible walls.

4. The aircraft according to claim 1, wherein the aerodynamic structure comprises a plurality of cavities, at least cavity of the plurality of cavities being inflatable.

5. The aircraft according to claim 4, wherein the aerodynamic structure comprises:
a first inflatable cavity delimited by a first flexible wall and a second flexible wall each having first lateral edges connected to one another and to the support in a sealed manner and second lateral edges connected to one another and to the support in a sealed manner, the first flexible wall having an outer face which, when the first cavity is in the inflated state, has a geometry identical to that of the aerodynamic surface,
a second cavity separated from the first inflatable cavity by the second flexible wall and delimited by the second flexible wall and the support, and,
internal meshes, situated in the first inflatable cavity, connecting the first flexible wall and the second flexible wall.

6. The aircraft according to claim 4, wherein aerodynamic structure comprises a first inflatable cavity and a second inflatable cavity, the first inflatable cavity and the second inflatable cavity each having a first flexible wall, a second flexible wall, and a third flexible wall, the first flexible walls of the first inflatable cavity and the second inflatable cavity forming at least a part of the aerodynamic surface of the aerodynamic structure, the second flexible walls of the first inflatable cavity and the second inflatable cavity bearing against the support, the third flexible walls of the first inflatable cavity and the second inflatable cavity bearing against one another.

7. The aircraft according to claim 1, wherein the aerodynamic structure comprises a plate or sheet covering at least part of the outer face of the flexible wall.

8. The aircraft according to claim 1, wherein the connection system comprises a bonding film interposed between the flexible wall and the support.

9. The aircraft according to claim 1, wherein the aerodynamic structure comprises a plurality of connection systems.

10. The aircraft according to claim 9, wherein at least one connection system of the plurality of connection systems comprises a slide which has an elongate housing connected to the support and a bead or an insert connected to the flexible wall and configured to be positioned in the elongate housing, the elongate housing having a constricted opening with a cross section smaller than that of the bead or of the insert.

11. The aircraft according to claim 9, wherein at least one connection system of the plurality of connection systems comprises a profile element separate from the support and connected to the support by fastening elements, the flexible wall cooperating with the profile element.

12. The aircraft according to claim 1, wherein the aerodynamic structure comprises a pressure regulation system comprising a pressurized fluid supply and an activatable control or a calibrated control configured to regulate a pressure of the fluid in the inflatable cavity.
